(19) United States
(12) Patent Application Publication
(10) Pub. No.: US 2026/0200509 A1
(43) Pub. Date: Jul. 16, 2026

(54) RAILWAY BRAKING SYSTEM FOR A RAIL VEHICLE AND METHOD FOR ASSEMBLING AND/OR DISASSEMBLING A RAILWAY BRAKING SYSTEM

(71) Applicant: WABTEC Hauts-de-France, Amiens (FR)

(72) Inventors: Fabrice LAURENT, Contay (FR); Claudino GONCALVES, Ribeaucourt (FR)

(73) Assignee: WABTEC Hauts-de-France, Amiens (FR)

(21) Appl. No.: 19/127,973

(22) PCT Filed: Nov. 6, 2023
(86) PCT No.: PCT/FR2023/051732

§ 371 Date: May 7, 2025

(30) Foreign Application Priority Data
Nov. 7, 2022 (FR) FR2211544

(51) Int. Cl. B61H 5/00; B61H 13/38

(52) U.S. Cl. CPC B61H 5/00; B61H 13/38

(57) ABSTRACT

The invention relates to a railway braking system (2) configured to act on a rotary braking member (3) of a rail vehicle (1) by means of a lining (4) and comprising a braking unit provided extending in a longitudinal direction (L) and generally orthogonal to an axis of rotation (R) of the rotary member, and a fixing interface (6) secured to the braking unit and fixed to a support (5) of the vehicle in an assembly direction (A) perpendicular to the longitudinal direction and to the axis of rotation, and provided with a mounting block (20) mounted by nesting with the support in the assembly direction and having at least one bearing face (31) and fixing members (34, 35) of the first bearing face which extend in a direction distinct from the assembly direction.

### TECHNICAL FIELD OF THE INVENTION

The invention relates to the field of rail vehicle braking. It relates more particularly to a braking system for a rail vehicle with brakes with at least one lining, configured to act on a braking member of said rail vehicle via said at least one lining. It also relates to the rail vehicles including such systems.

### PRIOR ART

Rail vehicles “with brakes with at least one lining” are generally equipped with braking systems with service and/or parking brake cylinders, including for example a piston movable under the effect of a pressurised fluid, the movement of this piston actuating a brake rigging and causing a braking action such as the clasping of a brake disk by the lining of this rigging. The cylinder and the rigging form what can be called a braking unit.

Such a braking system is mounted on the rail vehicle, to be in contact with the brake disks or with the wheels.

This braking system can be mechanically secured onto a support formed directly or indirectly by a bogie, or by an axle fixed to the bogie, or by another device of the drive motor or gearbox type also mounted on the bogie.

The braking action generates forces which can be transmitted, via levers and the connection device, to the support to which the braking system is secured.

In particular, when the braking system is provided with force-transmission connecting rods which are mechanically secured on the one hand to lining carriers and on the other hand to the support to which the braking system is secured, most of the forces can be transmitted to the support via the force-transmission connecting rods.

In particular, the braking system can include a fixing interface secured onto the braking unit and to which the force-transmission connecting rods are secured. This fixing interface can have mounting orifices for securing it onto the support of the vehicle.

In general, the fixing interface is mounted on the unit, with the force-transmission rods that are secured to the lining carriers, before the mounting onto the support.

Then, the system formed by the unit and the fixing interface is assembled to the support, with the lining carriers disposed on either side of the disc or of the wheel of the vehicle, the unit which extends longitudinally according to a radius of the disc or of the wheel, and the fixing interface which is located opposite the support, in a direction for example orthogonal to that of extension of the unit.

To secure the fixing interface to the support, mounting screws are inserted, for example vertically, from the side of the support that is opposite to the unit, through the support to the mounting orifices.

It is therefore necessary to have both access on the side of the support that is opposite to the unit and space to insert a tool therein and manoeuvre it.

### DISCLOSURE OF THE INVENTION

The invention relates to a railway braking system of the type of that described above, having improved performance, while being simple, convenient and economical.

The object of the invention is therefore, under a first aspect, a railway braking system for a rail vehicle with brakes with at least one lining, configured to act on at least one rotary braking member of the rail vehicle via the at least one lining and including a braking unit provided with a brake rigging having the at least one lining and a brake cylinder configured to actuate the brake rigging, the braking unit extending in a longitudinal general direction generally orthogonal to an axis of rotation of the at least one rotary braking member, and a fixing interface secured to the braking unit and configured to be fixed onto a support of the rail vehicle in an assembly direction generally perpendicular to the longitudinal general direction and to the axis of rotation, characterised in that the fixing interface is provided with a mounting block configured to be mounted by nesting with the support of the vehicle in the assembly direction and having at least one bearing face and members for fixing the first bearing face which extend in a direction distinct from the assembly direction.

The system according to the invention uses, for its attachment to the support of the vehicle, a cooperation by the bearing face of the mounting block which can preferably be flat.

The assembly, in particular the nesting of the mounting block, is carried out in the general assembly direction which is generally perpendicular to the longitudinal general direction of the braking unit and to the axis of rotation of the rotary braking member.

However, according to the general arrangement of the railway braking system with respect to the support of the vehicle and with respect to the rotary braking member of the vehicle, access can be reduced in the general assembly direction.

Via the system according to the invention, the mechanical securing of the mounting block is carried out in a direction distinct from the assembly direction.

For example, the longitudinal general direction of the braking unit is substantially horizontal while the general assembly direction is substantially vertical.

In other words, the securing of the mounting block is possible outside of the space allocated in the general assembly direction.

In particular, the securing of the mounting block can be carried out rather in a direction substantially parallel to the axis of rotation of the rotary braking member of the vehicle, or rather substantially parallel to the general direction of extension of the braking unit.

The system according to the invention thus facilitates the securing of the braking system with the vehicle, especially when the space is rather limited between the braking unit and the support or, in other words, above and below the mounting block.

Preferred, simple, convenient and economical features of the system according to the invention are presented below.

The fixing members extend in a fixing direction substantially perpendicular to the assembly direction, at least partially pass through the mounting block and are configured to position it relative to the support of the vehicle and fix it to the latter.

The mounting block is provided with orifices passing all the way through and opening on the one hand onto a first bearing face and on the other hand onto a second bearing face opposite to the first bearing face, whereby the fixing members are introduced from one or the other of the first and second bearing faces for the assembly of the mounting block with the support of the vehicle.

The system includes a suspension mechanism interposed between the braking unit and the mounting block, which has a mounting face distinct from the at least one bearing face and configured for mechanically securing the suspension mechanism in the assembly direction.

The braking unit includes a connection device mechanically secured on the one hand to the suspension mechanism and on the other hand to the brake rigging, which includes levers mounted movably in rotation about the connection device, and a service and/or parking brake housed at least partially in the cylinder and configured to act on the braking member by the actuation of the levers of the brake rigging.

The mounting block is provided with at least one guide and/or foolproofing member.

The at least one guide and/or foolproofing member is formed by a notch or a protrusion provided in the at least one bearing face and configured to cooperate with a complementary protrusion or a complementary notch, respectively.

The fixing interface is provided with an intermediate part configured to be mechanically secured on the one hand with the support of the vehicle in the assembly direction and on the other hand with the mounting block by the at least one bearing face in the direction distinct from the assembly direction.

The system includes at least one lining carrier on which at least one said lining is mounted and at least one force-transmission connecting rod mechanically secured on the one hand to the intermediate part of the fixing interface and on the other hand to the lining carrier.

The intermediate part is provided with a body having a central recess into which the mounting block is nested and with at least one additional bearing face, for example protruding in the central recess, provided to face the at least one bearing face of the mounting block.

The object of the invention is also, according to a second aspect, a method for assembling and/or disassembling a railway braking system as described above on a rail vehicle, including a step of nesting and/or disengaging the mounting block of the fixing interface with the support of the vehicle in the assembly direction, and mechanically securing the mounting block in a direction distinct from the assembly direction by the at least one bearing face and by the members for fixing the first bearing face.

When the fixing interface of the railway braking system is provided with an intermediate part configured to be mechanically secured on the one hand with the support of the vehicle in the assembly direction and on the other hand with the mounting block by the at least one bearing face in the direction distinct from the assembly direction, the method includes a step of assembling the intermediate part in the assembly direction with the support of the vehicle, then nesting the mounting block with the intermediate part in the assembly direction then mechanically securing the mounting block in the direction distinct from the assembly direction.

The method further includes a step of releasing the mounting block from the intermediate part in the direction distinct from the assembly direction, then disengaging the mounting block from the intermediate part in the assembly direction, then disassembling the intermediate part from the support of the vehicle.

The object of the invention is also, according to a third aspect, a rail vehicle with brakes with at least one lining, including at least one railway braking system as described above, configured to act on at least one rotary braking member of said rail vehicle via said at least one lining.

The at least one rotary braking member is formed by a disc or by a wheel.

### BRIEF DESCRIPTION OF THE DRAWINGS

The disclosure of the invention will now be continued by the description of exemplary embodiments, given below for illustrative and non-limiting purposes, in reference to the appended drawings.

FIG. 1 partially illustrates, in a side view and in a partial cross-section, a rail vehicle provided with a railway braking system secured onto a support of the vehicle and acting on a brake disk of the rail vehicle via linings.

FIG. 2 shows only partially and in an isolated manner the railway braking system, which is also partially disassembled.

FIG. 3 shows a first operation of mounting the railway braking system onto the support of the vehicle.

FIG. 4 shows a second operation of mounting the railway braking system onto the support of the vehicle.

FIG. 5 is a detailed view of the railway braking system.

FIG. 6 is a cross-sectional view labelled A-A in FIG. 5.

FIG. 7 is a cross-sectional view labelled B-B in FIG. 6.

FIG. 8 is a view similar to that of FIG. 7, taken according to an offset cutting plane and showing an alternative embodiment of the railway braking system.

FIG. 9 is a view similar to that of FIG. 7 showing another alternative embodiment of the railway braking system.

### DETAILED DESCRIPTION

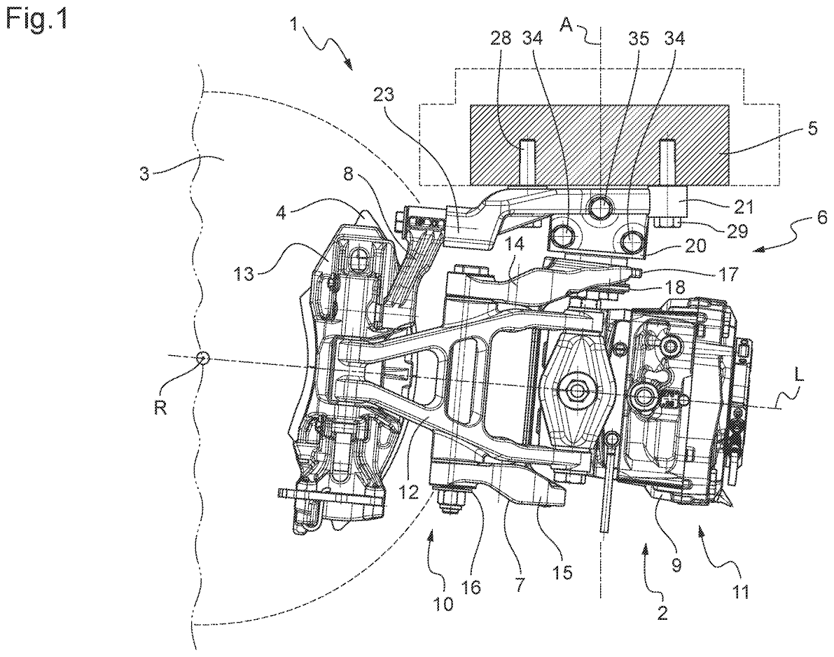

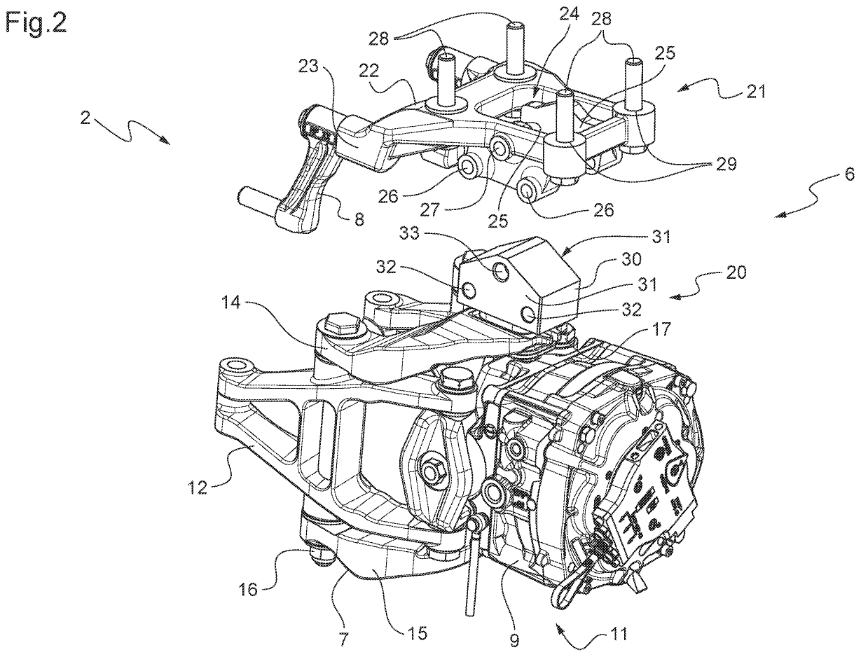

FIGS. 1 to 4 partially illustrate a rail vehicle 1 provided with a railway braking system 2 configured to act on a rotary braking member, formed here by a brake disc 3, of the rail vehicle 1 via linings 4.

The railway braking system 2 is mechanically secured to a support 5, which can be formed directly or indirectly by a bogie, or by an axle support fixed to the bogie, or by another device of the drive motor or gearbox type also mounted on the bogie.

Because of the movements inherent to the rail vehicle 1 both in the rolling phase and in the braking or brake-release phase, the railway braking system 2 is mounted here “suspended” with respect to the support 5.

The railway braking system 2 is here mechanically secured to the rail vehicle 1 only via the support 5, through a fixing interface 6 itself mechanically secured on the one hand to a connection device 7 and to force-transmission connecting rods 8 of the railway braking system 2.

The braking action generates braking forces that are thus transmitted to the rail vehicle 1 via the support 5 and via the fixing interface 6, the connection device 7 and the force-transmission connecting rods 8.

In reference to FIGS. 1 to 4 which show the railway braking system 2 with or without the support 5 and the brake disc 3 of the vehicle 1, the railway braking system 2 includes a braking unit which is provided with a brake rigging 10 and a service and/or parking brake 11 configured to act on the brake disc 3 via the brake rigging 10.

The service and/or parking brake 11 conventionally includes a cylinder 9, here of the pneumatic type.

The brake rigging 10 is provided with movable levers 12 mechanically secured at one end to the cylinder 9 of the service and/or parking brake 11, and with lining carriers 13 which are mechanically secured to a respective opposite end of the levers 12 and which carry the linings 4.

The force-transmission connecting rods 8 are mechanically secured to the lining carriers 13.

The movable levers 12 are configured to be actuated by the service and/or parking brake 11.

The connection device 7, which is part of the braking unit, includes here a lower part 14, an upper part 15 connected to the upper part by an intermediate part (not shown), and pivot axes 16 about which the levers 12 are movably mounted.

In the example illustrated, the lower part 14, the upper part 15 and the intermediate part are formed in one piece.

The cylinder 9 of the service and/or parking brake 11 is therefore secured here to the connection device 7 via the levers 12 that it pivotably carries.

The connection device 7 further includes a fixing portion 17 by which it is fixed to the fixing interface 6, together with the cylinder 9 and the levers 12.

The railway braking system 2 further includes a suspension mechanism 18 interposed between the fixing interface 6 and the connection device 7 to which the brake cylinder 9 is connected via the levers 12.

In the example illustrated, the braking unit extends in a longitudinal general direction L generally orthogonal to an axis of rotation R of the brake disc 3.

In addition, the braking system 2 is assembled here, via the fixing interface 6, to the support 5 of the vehicle 1 in an assembly direction A generally perpendicular to the longitudinal general direction L and to the axis of rotation R.

For example, the longitudinal general direction L is substantially horizontal while the assembly direction A is substantially vertical.

The fixing interface 6 is provided here with a mounting block 20 and with an intermediate part 21, also called anchor part.

In the example illustrated, the fixing interface 6 is configured so that the mounting block 20 is directly mechanically secured on the one hand to the suspension mechanism 18 and on the other hand to the intermediate part 21 which is in turn configured to also be directly mechanically secured to the support 5 of the vehicle 1.

In particular, the mounting block 20 and the intermediate part 21 are configured to be assembled by nesting in the assembly direction A and mechanically secured to one another in a direction distinct from the assembly direction A.

The intermediate part 21 is provided with a first body 22 from which extensions 23 to which the force-transmission connecting rods 8 are assembled protrude.

The first body 22 has a central recess 24 in which the mounting block 20 is nested and two walls forming “complementary” bearing faces 25 each arranged protruding in the central recess 24 and facing one another.

The first body 22 further has a plurality of first fixing orifices opening into the central recess 24, including first positioning and fixing orifices 27 and first fixing orifices 26 arranged here through the complementary bearing faces 25 only.

The first fixing orifices 26, 27 are here all oriented in the direction distinct from the assembly direction A.

The first body 22 also has other fixing orifices 29 arranged passing all the way through the first body 22, oriented in the assembly direction A, and provided to receive fixing screws 28 for mechanically securing the intermediate part 21 with the support 5 of the vehicle 1.

The mounting block 20 is provided with a second body 30 defining here two bearing faces 31, also called first bearing face and second bearing face, where a plurality of second fixing orifices open, including a second positioning and fixing orifice 33 and second fixing orifices 31.

The second body 30 of the mounting block 20 is nested into the central recess 24 of the first body 22 of the intermediate part 21 so that the complementary bearing faces 25 are each located facing and in immediate proximity to the bearing faces 31, and the railway braking system 2 includes members for fixing the bearing faces 31 with the complementary bearing faces 25 including, in the example illustrated, a positioning and fixing member 35 passing through at least one of the first positioning and fixing orifices 27 and the second centring and fixing orifice 33, and fixing members 34 passing through at least some of the first fixing orifices 26 and the second fixing orifices 32.

The fixing members thus extend in the direction distinct from the assembly direction A.

Moreover, the bearing faces 31 and complementary bearing faces 25 are here generally flat and arranged so as to form a flat bearing between the mounting block 20 and the intermediate part 21.

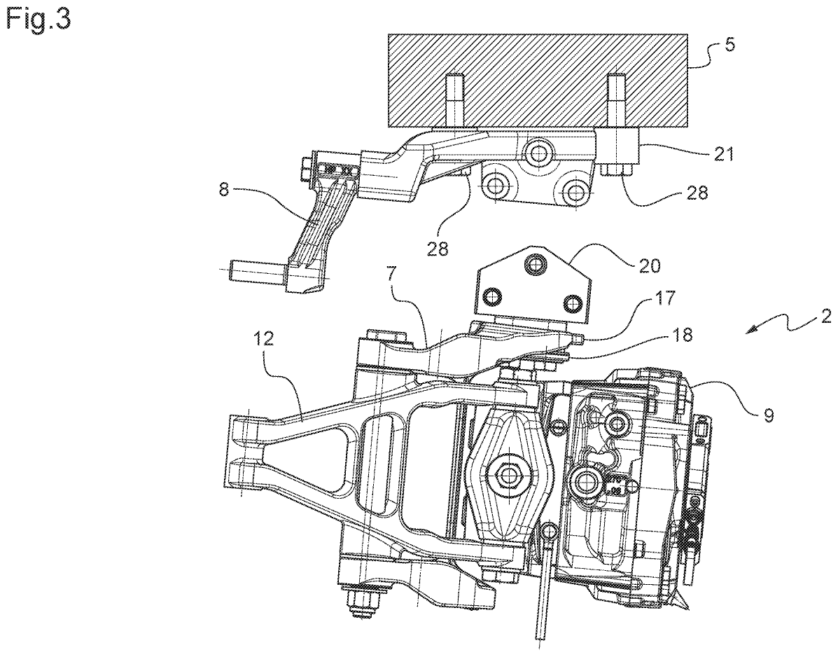

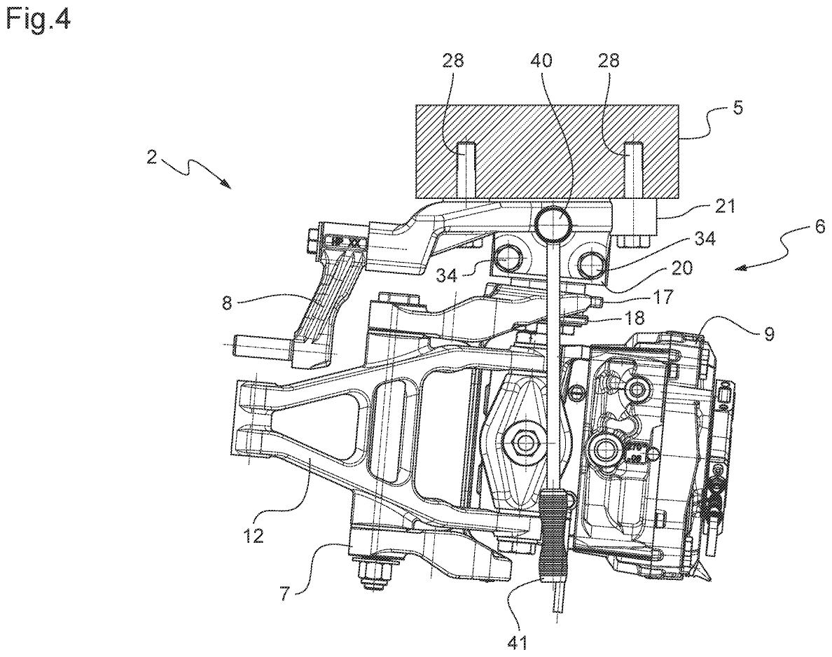

FIGS. 3 and 4 show the method for assembling the railway braking system 2 onto the support 5 of the vehicle 1 via the fixing interface 6.

In FIG. 3, the intermediate part 21 together with the force-transmission connecting rods 8 are mechanically secured to the support 5 via the fixing screws 28 inserted in the assembly direction.

The access here is particularly easy without the presence of the rest of the railway braking system 2.

In other words, the intermediate part 21 is mounted separately onto the support 5.

The rest of the railway braking system 2, including in particular the cylinder 9, the levers 12, the connection device 7, the suspension mechanism 18 and the mounting block 20 already assembled, can then be approached from the intermediate part 21 in the assembly direction.

In FIG. 4, the mounting block 20 is nested into the intermediate part 21, with the bearing faces and complementary bearing faces facing each other and in immediate proximity, then the positioning and fixing member 35 is inserted through one of the first positioning and fixing orifices 27 and the second positioning and fixing orifice 33, then the fixing members 34 are inserted through first fixing orifices 26 and the second fixing orifices 32.

Since the fixing members extend in the direction distinct from the assembly direction, they can be manoeuvred with a tool 40, for example of the socket wrench type or similar, having a handle that runs along the assembly direction, in a particularly reduced footprint.

More generally, the method for assembling and/or disassembling the railway braking system 2 includes a step of nesting and/or disengaging the mounting block 20 from the fixing interface 6 with the support 5 in the assembly direction, and mechanically securing the mounting block 20 in a direction distinct from the assembly direction.

When the fixing interface 6 is provided with an intermediate part 21 like that described above, the method first includes a step of mounting in the assembly direction the intermediate part 21 with the support 5, then nesting in the assembly direction the mounting block 20 with the intermediate part 21 then mechanically securing the mounting block 20 in the direction distinct from the assembly direction.

For disassembly, the method further includes a step of releasing the mounting block 20 from the intermediate part 21 in the direction distinct from the assembly direction, then disengaging the mounting block 20 from the intermediate part 21 in the assembly direction, then disassembling the intermediate part 21 from the support 5.

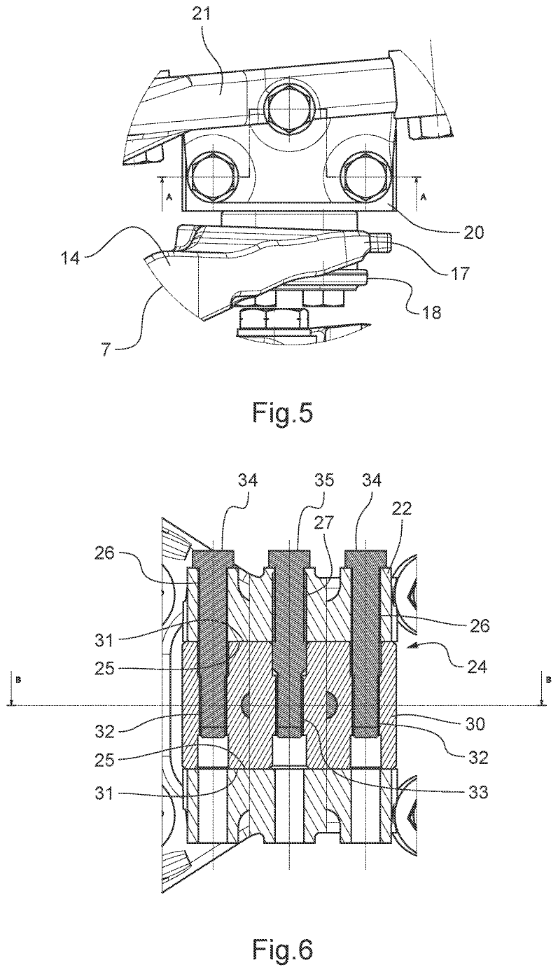

FIG. 5 is a detail of FIG. 4, showing the assembly of the suspension mechanism 18 with the attachment portion 17 of the upper part 14 of the connection device 7, the mounting block 20 and the intermediate part 21.

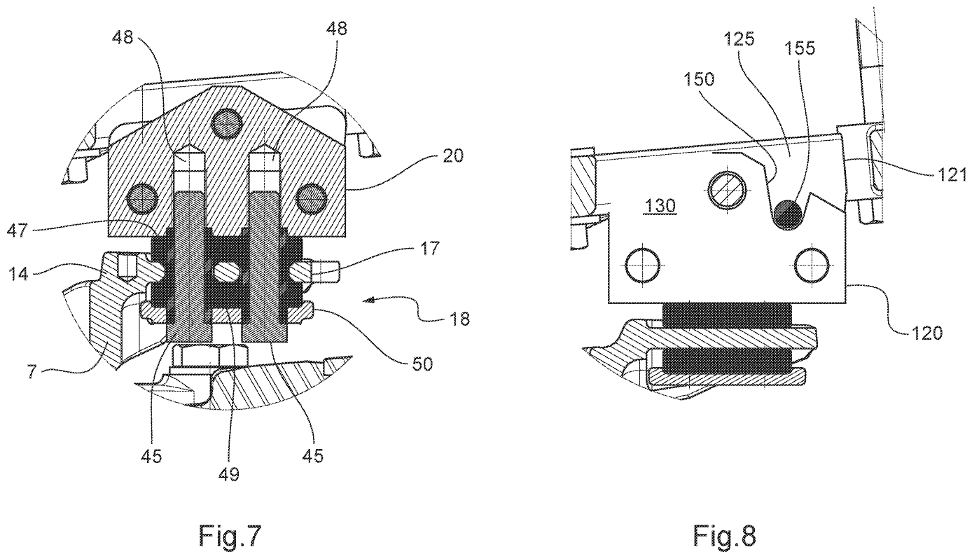

FIGS. 6 and 7 are cross-sections respectively labelled A-A and B-B in FIGS. 5 and 6.

In FIG. 6, the second body 30 of the mounting block is fitted into the central recess 24 of the first body 22 of the intermediate part so that the complementary bearing faces 25 are each located facing and in the immediate proximity of the bearing faces 31.

The members 35, 34 for fixing the bearing faces 31 with the complementary bearing faces 25 pass through one of the first positioning and fixing orifices 27 and the second positioning and fixing orifice 33, and also at least some of the first fixing orifices 26 and the second fixing orifices 32.

The fixing members thus extend in the direction distinct from the assembly direction.

Moreover, the bearing faces 31 and complementary bearing faces 25 form a flat bearing between the mounting block and the intermediate part.

In other words, the fixing members 34, 35 extend in the fixing direction substantially perpendicularly to the assembly direction, at least partially pass through the mounting block and are configured to position it with respect to the support 5 of the vehicle 1 and attach it thereto via the intermediate part.

In particular, the securing of the mounting block 20 can be carried out in a direction substantially parallel to the axis of rotation of the disc.

The fixing members can be inserted from one or the other of the bearing faces 31 for the assembly of the mounting block.

FIG. 7 shows in more detail the securing of the suspension mechanism 18 with the mounting block 20 and the attachment portion 17 of the upper part 14 of the connection device 7.

The railway braking system 2 includes complementary fixing screws 45 inserted into holes 48 arranged in a mounting face 47 of the mounting block 20, distinct from the bearing faces 31.

In the example illustrated, the suspension mechanism 18 is provided with a first and a second damping buffer 49, 50 mounted on either side of the attachment portion 17.

Complementary holes are formed so that the complementary fixing screws 45 pass through the damping buffer 50, the attachment portion 17 and the damping buffer 49 before being inserted into the holes 48 which are tapped.

Spacer rings can be housed in the complementary holes to limit the tightening of the complementary fixing screws 45 and the deformation of the damping buffer(s) 49, 50

FIG. 8 shows an alternative embodiment of the system, in which the same references as above are used for similar elements, but to which the number 100 has been added. The mounting block 120 is provided with at least one guide and/or foolproofing member formed here by a notch 150 arranged in the second body 130 and in particular in the bearing face, while a complementary protrusion 155 is formed on the complementary bearing face 125 of the intermediate part 121.

More generally, the at least one guide and/or foolproofing member is formed by a notch or a protrusion arranged in the at least one bearing face and configured to cooperate with respectively a complementary protrusion or a complementary notch of the complementary bearing face.

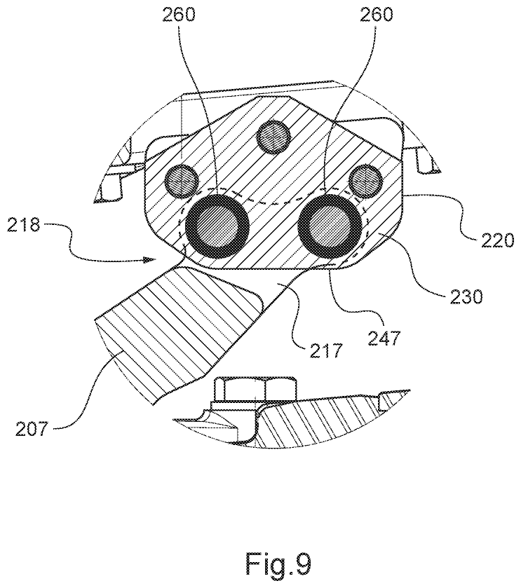

FIG. 9 shows an alternative embodiment of the system, in which the same references as above are used for similar elements, but to which the number 200 has been added. The suspension mechanism 218 differs from that described above in that it is provided with a plurality of cylinders 260 mounted suspended in the second body 230 of the mounting block 220, and the attachment portion 217 of the connection device 207 is directly secured to the cylinders 260 through the mounting face 247.

In the railway braking system 2 described above, the assembly, in particular the nesting of the mounting block 20, is carried out in the general assembly direction which is generally perpendicular to the longitudinal general direction and to the axis of rotation of the rotary braking member. However, depending on the general arrangement of the railway braking system with respect to the support of the vehicle and with respect to the disc, access may be reduced in the general assembly direction. Via the system according to the invention, the mechanical securing of the mounting block is carried out in a direction distinct from the assembly direction. In other words, the securing of the mounting block is possible outside of the space allocated in the general assembly direction. In particular, the securing of the mounting block can be carried out rather in a direction substantially parallel to the axis of rotation of the rotary braking member of the vehicle, or rather substantially parallel to the general direction of extension of the braking unit. The system according to the invention thus facilitates the securing of the braking system with the vehicle, especially when the space is rather limited between the braking unit and the support or, in other words, above and below the mounting block.

Non-illustrated alternatives are presented below.

The intermediate part can be formed in one piece with the support.

There can be more or fewer members for fixing the mounting block with the intermediate part and/or the support.

The fixing members extend in a fixing direction substantially perpendicular to the assembly direction, and in particular substantially parallel to the general direction of extension of the brake braking unit rather than substantially parallel to the axis of rotation of the disc.

The suspension mechanism only includes one suspended cylinder, with or without a suspension connecting rod.

The railway braking system does not have a suspension mechanism.

The service and/or parking brake can be electromechanical, or hydraulic, or electrical, or manual rather than pneumatic.

More generally, the invention is not limited to the examples described and shown.

1. A railway braking system for a rail vehicle with brakes with at least one lining, configured to act on at least one rotary braking member of the rail vehicle via the at least one lining and including
a braking unit provided with a brake rigging having the at least one lining and a brake cylinder configured to actuate the brake rigging, the braking unit extending in a longitudinal general direction generally orthogonal to an axis of rotation of the at least one rotary braking member, and a fixing interface secured to the braking unit and configured to be fixed onto a support of the rail vehicle in an assembly direction generally perpendicular to the longitudinal general direction and to the axis of rotation, characterised in that the fixing interface is provided with a mounting block configured to be mounted by nesting with the support of the vehicle in the assembly direction and having at least one bearing face, and members for fixing the at least one bearing face which extend in a direction distinct from the assembly direction.

2. The railway braking system of claim 1, wherein the fixing members extend in a fixing direction substantially perpendicular to the assembly direction, at least partially pass through the mounting block and are configured to position it with respect to the support of the vehicle and fix it to the latter.

3. The railway braking system of claim 2, wherein the mounting block is provided with orifices passing all the way through and opening on the one hand onto a first bearing face and on the other hand onto a second bearing face opposite to the first bearing face, whereby the fixing members are introduced from one or the other of the first and second bearing faces for the assembly of the mounting block with the support of the vehicle.

4. The railway system of claim 1, wherein the braking system includes a suspension mechanism interposed between the brake cylinder and the mounting block, which has a mounting face distinct from the at least one bearing face and configured for mechanically securing the suspension mechanism in the assembly direction.

5. The railway braking system of claim 4, wherein the braking unit includes a connection device mechanically secured on the one hand to the suspension mechanism and on the other hand to the brake rigging, which includes levers mounted movably in rotation about the connection device, and a service and/or parking brake housed at least partially in the cylinder and configured to act on the rotary braking member by actuating the levers of the brake rigging.

6. The railway system of claim 1, wherein the mounting block is provided with at least one guide and/or foolproofing member.

7. The railway braking system of claim 6, wherein the at least one guide and/or foolproofing member is formed by a notch or a protrusion arranged in the at least one bearing face and configured to cooperate with a complementary protrusion or a complementary notch, respectively.

8. The railway system of claim 1, wherein the fixing interface (6) is provided with an intermediate part configured to be mechanically secured on the one hand with the support of the vehicle in the assembly direction and on the other hand with the mounting block by the at least one bearing face in the direction distinct from the assembly direction.

9. The railway braking system of claim 8, wherein the braking unit includes at least one lining carrier on which at least one said lining is mounted and at least one force-transmission connecting rod mechanically secured on the one hand to the intermediate part of the fixing interface and on the other hand to the lining carrier.

10. The railway system of claim 8, wherein the intermediate part is provided with a body having a central recess in which the mounting block is nested and with at least one complementary bearing face provided to come opposite the at least one bearing face of the mounting block.

11. A method for assembling and/or disassembling a railway braking system for a rail vehicle with brakes with at least one lining, configured to act on at least one rotary braking member of the rail vehicle via the at least one lining and including a braking unit provided with a brake rigging having the at least one lining and a brake cylinder configured to actuate the brake rigging, the braking unit extending in a longitudinal general direction generally orthogonal to an axis of rotation of the at least one rotary braking member, and a fixing interface secured to the braking unit and configured to be fixed onto a support of the rail vehicle in an assembly direction generally perpendicular to the longitudinal general direction and to the axis of rotation, characterised in that the fixing interface is provided with a mounting block configured to be mounted by nesting with the support of the vehicle in the assembly direction and having at least one bearing face, and members for fixing the at least one bearing face which extend in a direction distinct from the assembly direction, the method comprising nesting and/or disengaging the mounting block of the fixing interface with the support of the vehicle in the assembly direction, and mechanically securing the mounting block in a direction distinct from the assembly direction by the at least one bearing face and by the members for fixing the at least one bearing face.

12. The method of claim 11, wherein the fixing interface of the railway braking system is provided with an intermediate part configured to be mechanically secured on the one hand with the support of the vehicle in the assembly direction and on the other hand with the mounting block by at least one bearing face in the direction distinct from the assembly direction, and the method includes a step of mounting in the assembly direction the intermediate part with the support of the vehicle, then nesting in the assembly direction the mounting block with the intermediate part then mechanically securing the mounting block in the direction distinct from the assembly direction.

13. The method of claim 12, wherein the baking unit includes a step of releasing the mounting block from the intermediate part in the direction distinct from the assembly direction, then disengaging the mounting block from the intermediate part in the assembly direction, then disassembling the intermediate part from the vehicle support.

14. A rail vehicle with brakes with at least one lining, including at least one railway braking system for a rail vehicle with brakes with at least one lining, configured to act on at least one rotary braking member of the rail vehicle via the at least one lining and including a braking unit provided with a brake rigging having the at least one lining and a brake cylinder configured to actuate the brake rigging, the braking unit extending in a longitudinal general direction generally orthogonal to an axis of rotation of the at least one rotary braking member, and a fixing interface secured to the braking unit and configured to be fixed onto a support of the rail vehicle in an assembly direction generally perpendicular to the longitudinal general direction and to the axis of rotation, characterised in that the fixing interface is provided with a mounting block configured to be mounted by nesting with the support of the vehicle in the assembly direction and having at least one bearing face, and members for fixing the at least one bearing face which extend in a direction distinct from the assembly direction, wherein the railway braking system is configured to act on at least one rotary braking member of said rail vehicle via said at least one lining.

15. The rail vehicle of claim 14, wherein the at least one rotary braking member is formed by a disc or by a wheel.
